(19) United States
(12) Patent Application Publication
(10) Pub. No.: US 2009/0257127 A1
(43) Pub. Date: Oct. 15, 2009

(54) IMAGING OPTICAL SYSTEM

(76) Inventors: Hiroaki Okayama, Osaka (JP); Motonobu Yoshikawa, Osaka (JP); Keiki Yoshitsugu, Hyogo (JP); Yoshiharu Yamamoto, Osaka (JP)

Correspondence Address: MCDERMOTT WILL & EMERY LLP, 600 13TH STREET, NW, WASHINGTON, DC, 20005-3096, US

(21) Appl. No.: 12/063,147

(22) PCT Filed: Aug. 4, 2006
(86) PCT No.: PCT/JP2006/315510

§ 371 Date: Feb. 7, 2008

(30) Foreign Application Priority Data
Aug. 8, 2005 (JP) 2005-229161

(51) Int. Cl. G02B 1/11

(52) U.S. Cl. 359/601

(57) ABSTRACT

An imaging optical system according to the present invention is provided with at least one lens element and comprises: an optical surface through which incident light transmits; and an antireflection structure provided in at least part of a peripheral region located in the periphery of a center region containing the center of an optical surface in one or more optical surfaces, wherein the peripheral region is within an optical effective diameter, and wherein the antireflection structure is a structure in which structural units having a predetermined shape are arranged periodically in the form of an array at a period smaller than a minimum wavelength of light whose reflection should be prevented in the incident light.

### RELATED APPLICATIONS

This application is the U.S. National Phase under 35 U.S.C. § 371 of International Application No. PCT/JP2006/315510, filed on Aug. 4, 2006, which in turn claims the benefit of Japanese Application No. 2005-229161, filed on Aug. 8, 2005, the disclosure of which Applications are incorporated by reference herein.

### TECHNICAL FIELD

The present invention relates to an imaging optical system. In particular, the present invention relates to an imaging optical system in which the reflection factor is suppressed on an optical surface while handling is easy and satisfactory mass productivity is obtained. The imaging optical system is suitably applicable to various imaging devices such as digital cameras.

### BACKGROUND ART

In recent years, the size of the digital camera market is in an increasing trend. In general, the digital camera market is roughly divided into a market where cameras of high magnification and high resolution are targeted and a market where compact cameras are targeted. On the other hand, aiming at further expansion of the market, a movement of market cultivation is arising for a new market where wide-angle type cameras and the like are targeted.

In imaging optical systems such as zoom lens systems for cameras of high magnification, a meniscus lens element having strong negative optical power is employed in some cases in order to realize high magnification in a state that comparative compactness is maintained. At that time, in some cases, a lens element having an optical surface of large maximum tilt angle is contained in the imaging optical system.

In imaging optical systems such as zoom lens systems for compact cameras, the purpose of size reduction requires that the thickness is reduced in the lens elements and the radius of curvature is reduced in the optical surfaces. Also at this time, in some cases, a lens element having an optical surface of large tilt angle need be employed in the imaging optical system.

Further, among the wide-angle type imaging optical systems, in imaging optical systems of a type that a lens unit having positive optical power is arranged on the most object side, the most object side surface of the lens system is convex to the object side. In particular, on the lens element located on the most object side, the peripheral region of the optical surface near the effective diameter has a large tilt angle.

On the other hand, on the optical surfaces of lens elements employed in such imaging optical systems, in general, a multilayer film (referred to as an antireflection multilayer film, hereinafter) for prevention of reflection is formed. When such an antireflection multilayer film is formed on an optical surface, the reflection factor can be reduced on the optical surface of the lens element. Nevertheless, the function of reducing the reflection factor achieved by the antireflection multilayer film has incident angle dependence. Thus, the antireflection effect varies near the center of the optical surface where the tilt angle is small and near the periphery of the optical surface where the tilt angle is large. This causes a problem that reflected light is generated and causes image quality degradation such as ghost and flare near the periphery of the optical surface where suppression of the reflection factor is insufficient.

In order to resolve this problem, in recent years, a technique has been developed in which a microscopic periodic structure is formed on an optical surface so that an antireflection function is imparted (e.g., Japanese Laid-Open Patent Publication No. 2003-322711 and Japanese Laid-Open Patent Publication No. 2003-329806). In the imaging optical systems disclosed in Japanese Laid-Open Patent Publication No. 2003-322711 and Japanese Laid-Open Patent Publication No. 2003-329806, a microscopic periodic structure is formed on the entire optical surface where the maximum tilt angle is large in a lens element, so that an antireflection effect is obtained on the optical surface.

### Patent Document 1: Japanese Laid-Open Patent Publication No. 2003-322711

### Patent Document 2: Japanese Laid-Open Patent Publication No. 2003-329806

### DISCLOSURE OF THE INVENTION

### Problems to be Solved by the Invention

Nevertheless, the imaging optical systems disclosed in Japanese Laid-Open Patent Publication No. 2003-322711 and Japanese Laid-Open Patent Publication No. 2003-329806 contain a lens element in which a microscopic periodic structure is formed on the entire optical surface. This causes difficulty in handling at the time of assembling. That is, in order that the imaging optical system should be assembled without damage in the microscopic periodic structure formed on the optical surface of the lens element, the lens edge need be used at the time of holding the lens element. This causes a problem of difficulty in achieving automation and in improving mass productivity. Further, in a case that the lens element located on the most object side among the lens elements employed in the imaging optical system has a shape that the surface apex protrudes to the object side, the necessity in practical use arises that the user touches the lens surface and that dirt need be removed. This causes possibility that the microscopic periodic structure is damaged or worn out.

The present invention has been devised in order to resolve the above-mentioned problems in the conventional art. An object of the present invention is to provide an imaging optical system in which the reflection factor is suppressed on an optical surface while handling is easy and satisfactory mass productivity is obtained.

### Solution to the Problems

One of the above-mentioned objects is achieved by the following imaging optical system. That is, the present invention relates to

an imaging optical system provided with at least one lens element, comprising:

an optical surface through which incident light transmits; and

an antireflection structure provided in at least part of a peripheral region located in the periphery of a center region containing the center of an optical surface in one or more optical surfaces, wherein

the peripheral region is within an optical effective diameter, and wherein

the antireflection structure is a structure in which structural units having a predetermined shape are arranged periodically in the form of an array at a period smaller than a minimum wavelength of light whose reflection should be prevented in the incident light.

### EFFECT OF THE INVENTION

According to the present invention, an imaging optical system is realized in which the reflection factor is satisfactorily suppressed on an optical surface while handling is easy and satisfactory mass productivity is obtained.

### BRIEF DESCRIPTION OF THE DRAWINGS

FIG. 1 is a schematic sectional view showing a configuration of an imaging optical system 1 according to Embodiment 1.

FIG. 2 is an enlarged view of a lens element 2 employed in an imaging optical system 1 shown in FIG. 1.

FIG. 3A is a schematic enlarged view showing an example of an antireflection structure, and is an enlarged view of a structure having structural units of conical shape.

FIG. 3B is a schematic enlarged view showing an example of an antireflection structure, and is an enlarged view of a structure having structural units of pyramid shape.

FIG. 4A is a schematic enlarged view showing an example of an antireflection structure, and is an enlarged view of a structure having structural units of bell shape.

FIG. 4B is a schematic enlarged view showing an example of an antireflection structure, and is an enlarged view of a structure having structural units of bell shape.

FIG. 5A is a schematic enlarged view showing an example of an antireflection structure, and is an enlarged view of a structure having structural units of truncated conical shape.

FIG. 5B is a schematic enlarged view showing an example of an antireflection structure, and is an enlarged view of a structure having structural units of truncated pyramid shape.

FIG. 6 is a graph showing the relation between the wavelength of incident light and the reflection factor for the case of a lens element in which a conventional common antireflection multilayer film is formed solely.

FIG. 7 is a graph showing the relation between the incident angle of incident light having a wavelength of 587 nm and the reflection factor for the case of a lens element in which a conventional common antireflection multilayer film is formed solely.

FIG. 8 is a graph showing the relation between the incident angle of incident light having a wavelength of 435 nm and the reflection factor for the case of a lens element in which a conventional common antireflection multilayer film is formed solely.

FIG. 9 is a graph showing the relation between the incident angle of incident light having a wavelength of 656 nm and the reflection factor for the case of a lens element in which a conventional common antireflection multilayer film is formed solely.

FIG. 10 is an enlarged view of a lens element 12 employed in an imaging optical system according to Embodiment 2.

FIG. 11 is an enlarged sectional part view of a lens element 22 employed in an imaging optical system according to Embodiment 3.

FIG. 12 is a schematic enlarged view showing the shape of an antireflection structure employed in a simulation, and is an enlarged view of an antireflection structure formed in a lens element located on the most object side of an imaging optical system in an example.

FIG. 13 is a graph showing the relation between the incident angle of incident light having a wavelength of 400 to 800 nm and the reflection factor for the case of a lens element in which an antireflection structure shown in FIG. 12 is formed.

FIG. 14 is a graph showing the relation between the wavelength of incident light and the reflection factor for the cases of a lens element in which an antireflection structure shown in FIG. 12 is formed and a lens element in which a conventional common antireflection multilayer film is formed solely.

### DESCRIPTION OF THE REFERENCE CHARACTERS

1 Imaging optical system
2, 12, 22 Lens element located on the most object side
3, 13, 23 Antireflection structure
4, 14 Antireflection multilayer film
5a, 5b, 5c Light beam
6 Lens barrel
24 Substrate
25 Sheet

### BEST MODE FOR CARRYING OUT THE INVENTION

### Embodiment 1

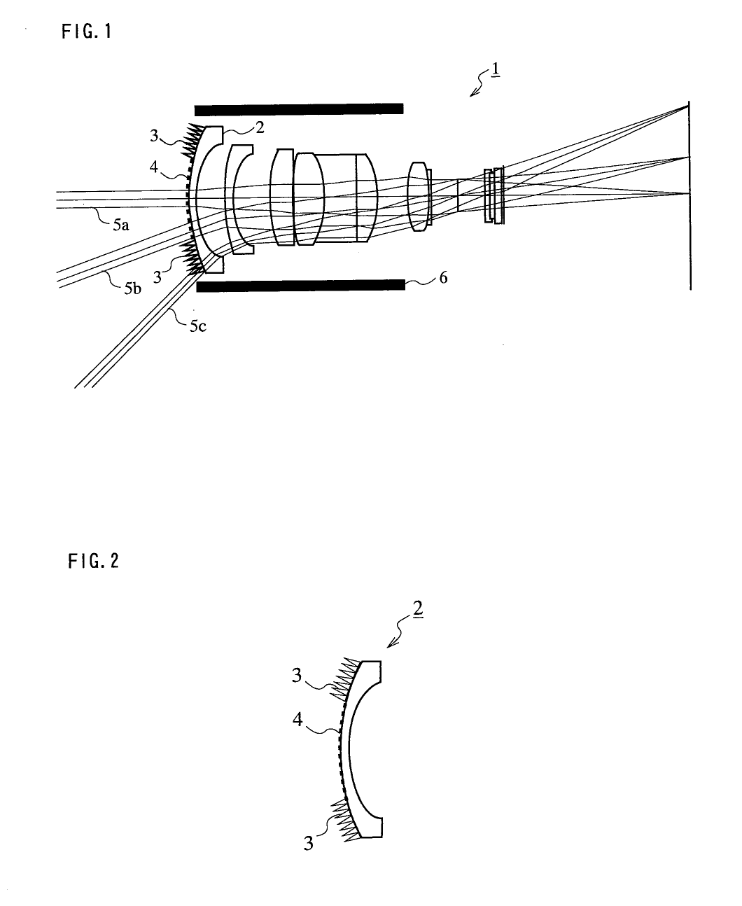

FIG. 1 is a schematic sectional view showing a configuration of an imaging optical system 1 according to Embodiment 1. FIG. 1 shows an example of an imaging optical system suitable for wide-angle image taking in which the focal length does not vary. The imaging optical system 1 is held by a lens barrel 6. Light beams 5a, 5b and 5c are light beams that pass through the imaging optical system 1. The light beam 5c is a light beam that passes at the maximum view angle of the imaging optical system 1.

FIG. 2 is an enlarged view of a lens element 2 located on the most object side among the lens elements employed in the imaging optical system 1 shown in FIG. 1. In FIG. 2, the lens element 2 has an antireflection structure 3 in at least part of a peripheral region (simply referred to as a “peripheral region”, hereinafter) located in the periphery of a center region (simply referred to as a “center region”, hereinafter) containing the center (the vicinity of the center) of the object side optical surface.

Further, it is preferable that a multilayer film is formed in at least part of the center region of the optical surface, and it is particularly preferable that the multilayer film is an antireflection multilayer film having an antireflection function. This reduces the reflection factor of unnecessary light (light that is reflected by the lens element 2 so as to form ghost and flare) in the incident light in the center region of the optical surface, and thereby reduces loss in the amount of light and degradation in the image quality. The following description is given for an exemplary case that the multilayer film formed in the center region is an antireflection multilayer film 4.

One of remarkable features of the present invention is that the lens element 2 has an antireflection structure 3 of specific structure in at least part of the peripheral region of the optical surface. This permits satisfactory prevention of reflection of unnecessary light in the incident light. Here, a method for determining the boundary between the peripheral region where the antireflection structure 3 is to be formed and the center region where the antireflection multilayer film 4 is to be formed is described later.

The antireflection structure is a structure in which structural units having a predetermined shape are arranged periodically in the form of an array at a period smaller than the lower limit of the wavelength of unnecessary light in the incident light (in general, wavelength of approximately 400 to 800 nm), that is, at a period smaller than the minimum wavelength of light whose reflection should be prevented in the incident light. When structural units having a predetermined shape are arranged periodically in the form of an array as described here, the apparent refractive index is changed continuously for the light whose reflection should be prevented, so that an antireflection function surface can be formed that is provided with reduced incident angle dependence and wavelength dependence in the transmission/reflection characteristics at the interface with the air layer.

When the antireflection structure is a structure in which a large number of structural units are arranged in two dimensions, the above-mentioned period indicates the period in the direction where the arrangement has the highest density.

Further, obviously, the antireflection structure indicates a structure for preventing the reflection of unnecessary light which should be prevented from being reflected. However, in addition to a mode that reflection of light whose reflection should be prevented is prevented completely, the present Embodiment 1 includes a mode that reflection of light whose reflection should be prevented is reduced to an extent that generation of ghost and flare by stray light is satisfactorily suppressed.

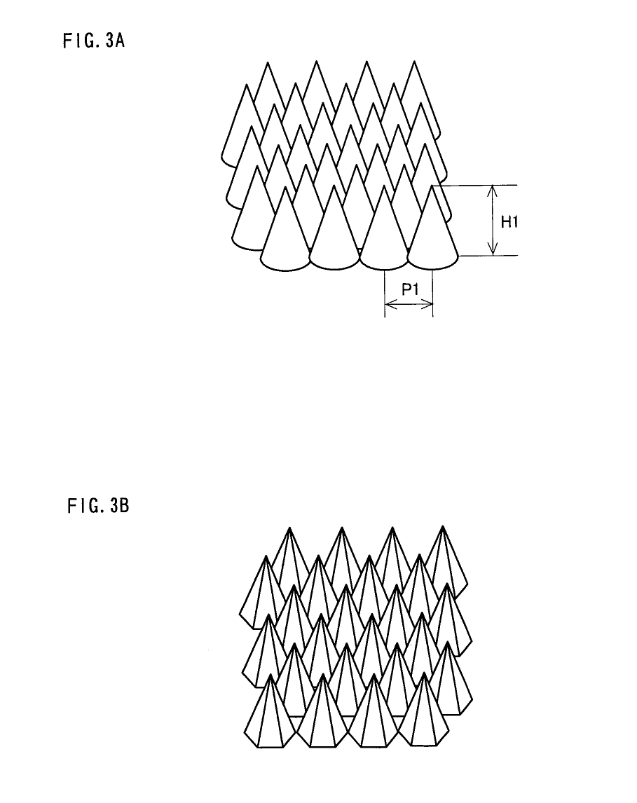

Antireflection structures employable in Embodiment 1 include a structure in which structural units having a protruding conical shape of height H1 are arranged periodically in the form of an array at period P1 as shown in the schematic enlarged view of FIG. 3A.

It is sufficient that the period P1 is substantially and approximately constant in one arrangement direction in the antireflection structure and is smaller than the minimum wavelength of light whose reflection should be prevented. However, from the point that the incident angle dependence and the wavelength dependence in the transmission/reflection characteristics at the interface with the air layer can be reduced further, it is preferable that the period P1 is ½ or smaller, or more preferably ⅓ or smaller, of the minimum wavelength of light whose reflection should be prevented. Here, for example, from the point of later-described manufacturability of the antireflection structure, it is preferable that the period P1 is not smaller than a practical value and, in general, is not smaller than approximately 1/10 of the minimum wavelength of light whose reflection should be prevented.

In the present Embodiment 1, as described above, the antireflection structure 3 may be a structure having structural units of, for example, conical shape (FIG. 3A). In this case, for example, it is preferable that an antireflection structure 3 is formed such that structural units having a height of 0.15 μm are arranged periodically in the form of an array at a period of 0.15 μm. The period of the antireflection structure may be, for example, 0.1 to 1 μm or so, and is preferably 0.15 to 0.5 μm or so.

Further, the height H1 of the structural units is not limited to a particular value. The height H1 of each structural unit need not be constant throughout the antireflection structure. However, a greater height H1 advantageously improves more the antireflection function against light (unnecessary light) whose reflection should be prevented in the incident light. Thus, it is preferable that the height H1 of the structural units is greater than or equal to the period P1 (the height of the smallest structural unit is greater than or equal to the period) and, more preferably, greater than or equal to 3 times of the period P1 (the height of the smallest structural unit is greater than or equal to 3 times of the period). Also in this case, for example, from the point of later-described manufacturability of the antireflection structure, it is preferable that the height H1 does not exceed a practical value and, in general, does not exceed approximately 5 times of the period P1 (the height of the largest structural unit does not exceed approximately 5 times of the period).

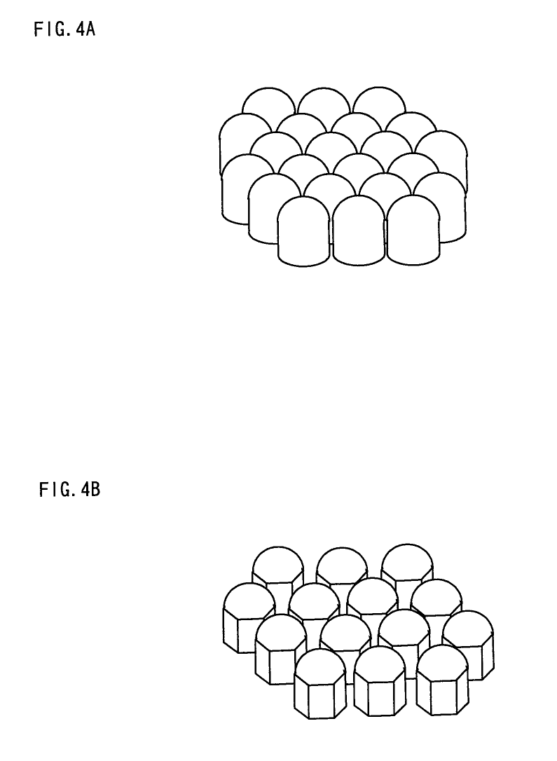

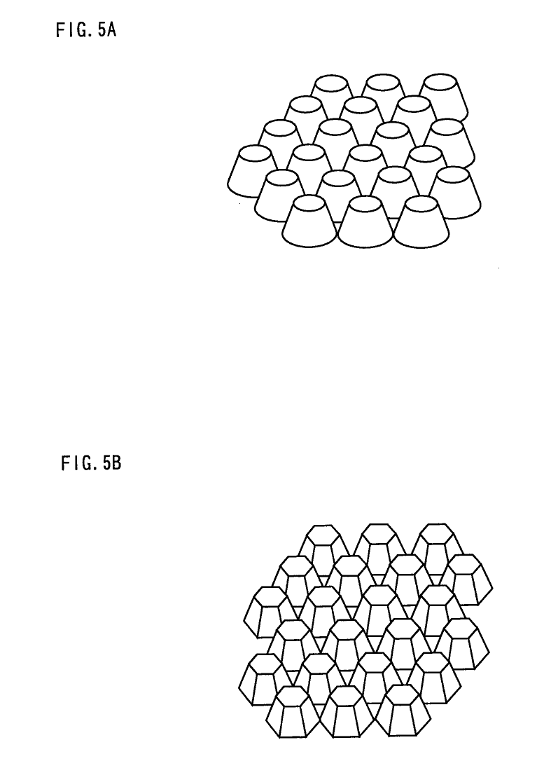

The structural units of the antireflection structure 3 are not limited to the structural units of the conical shape shown in FIG. 3A and may be, for example, structural units of pyramid shape (FIG. 3B) such as regular hexagonal pyramid shape and square pyramid shape. Further, these structural units are not limited to structural units of tapered shape, and may be structural units of bell shape (FIGS. 4A and 4B) having a rounded tip or alternatively structural units of truncated tapered shape such as truncated conical shape (FIG. 5A) and truncated pyramid shape (FIG. 5B). Furthermore, each structural unit need not have an exact geometric shape. That is, it is sufficient that each structural unit has substantially a tapered shape, a bell shape, a truncated tapered shape or the like.

Further, FIGS. 3A, 3B, 4A, 4B, 5A and 5B show antireflection structures each composed of a structure employing structural units of protruding shape. However, Embodiment 1 is not limited to a structure employing structural units of such protruding shape. For example, an antireflection structure may be employed in which structural units of recess shape such as tapered shape, bell shape and truncated tapered shape are arranged in plane periodically in the shape of an array at a period smaller than the minimum wavelength of light whose reflection should be prevented. Here, when the structural units of the antireflection structure have a recess shape, the depth of the structural units may be determined similarly to the case of the height H1 of the structural units of protruding shape. Further, structural units of protruding shape and structural units of recess shape may be employed simultaneously in a single antireflection structure. In the case of an antireflection structure employing structural units of protruding shape and structural units of recess shape simultaneously, it is preferable that the sum of the height of the protrusion and the depth of the recess falls within the above-mentioned range of the height H1. As such, in the antireflection structure employed in the present Embodiment 1, the shape and the like of the structural units are not limited to particular ones, as long as individual structural units are arranged periodically in the form of an array at a period smaller than the minimum wavelength of unnecessary light whose reflection should be prevented, so that the reflection of unnecessary light can be prevented satisfactorily.

In Embodiment 1, from the point that the refractive index of unnecessary light whose reflection should be prevented varies continuously at the interface with the air layer so that reflection of the unnecessary light can be prevented more satisfactorily, it is preferable to use: an antireflection structure employing structural units having a protruding shape of approximately tapered shape; an antireflection structure employing structural units having a recess shape of approximately tapered shape; and an antireflection structure employing simultaneously structural units having a protruding shape of approximately tapered shape and structural units having a recess shape of approximately tapered shape. Here, among those structural units of approximately tapered shape, the structural unit of approximately regular hexagonal pyramid shape is remarkably preferable from the point that the structural units can be arranged at a high filling factor and hence the refractive index of unnecessary light whose reflection should be prevented varies more continuously at the interface with the air layer so that reflection of unnecessary light can be prevented much more satisfactorily.

In the lens element 2 employed in Embodiment 1, the antireflection structure 3 is provided in at least part of the peripheral region of the optical surface. However, obviously, the antireflection structure 3 may be provided in the entire peripheral region.

The manufacturing method for the lens element 2 provided with the antireflection structure 3 is also not limited to a particular one. An exemplary method is as follows. First, a pattern is generated on a quartz glass substrate or the like by a technique such as electron beam lithography. Then, a shape identical to the antireflection structure 3 is formed by dry etching or the like. As a result of this precision processing, a precision master mold is obtained. Then, using the master mold, press molding is performed on a glass material having been softened by heating so that a glass antireflection structure molding die is obtained. Finally, using the antireflection structure molding die, press molding is performed on a material such as resin, so that a lens element 2 provided with the antireflection structure 3 is obtained. When such a method is adopted, the lens element 2 in which the antireflection structure 3 is provided in at least part of the peripheral region of the optical surface can be manufactured at low cost and in large quantities.

Next, a method for determining the boundary between the peripheral region where the antireflection structure 3 is to be formed and the center region where the antireflection multilayer film 4 is to be formed in the lens element 2 is described below.

The object side optical surface of the lens element 2 has, for example, a radius of curvature of approximately 53 mm, an effective radius of approximately 22 mm, and a tilt angle of approximately 24° at the outermost outline of the effective radius. Further, the image side optical surface of the lens element 2 has, for example, a radius of curvature of approximately 26 mm, an effective radius of approximately 18 mm, and a tilt angle of approximately 43° at the outermost outline of the effective radius. In the imaging optical system 1, among the light beams incident onto the lens element 2, the light beam 5c having the greatest image height has the maximum incident angle of as large as approximately 44°. Thus, for the purpose of compact construction of the lens barrel 6 that holds the imaging optical system 1, the diameter of the lens barrel need be reduced so that the amount of protrusion from the lens element 2 to the object side need be reduced.

As such, in some cases, in the object side optical surface of the lens element 2, the vicinity of the surface apex part protrudes to the object side relative to the lens barrel 6. In such cases, obviously, damage and dirt are caused easily on the optical surface near the optical axis (in the vicinity of the surface apex part). Thus, when an antireflection effect is to be imparted to an optical surface near the optical axis where damage and dirt are caused easily, an antireflection multilayer film 4 is suitable that has satisfactory scratching hardness and has a structure permitting easy removal of dirt.

On the other hand, in the peripheral region of the optical surface, the antireflection effect achieved by the antireflection multilayer film 4 is affected by the tilt angle of the optical surface where the antireflection multilayer film 4 is formed or the incident angle of the light beam. This causes loss in the amount of light and degradation in the image quality, in some cases. Further, in the peripheral region of the optical surface, since the lens barrel 6 that holds the lens element 2 protrudes to the object side, damage such as scratching by external force is less probable to be caused. Thus, in the peripheral region, the antireflection structure 3 having low incident angle dependence is suitable in place of the antireflection multilayer film 4.

Here, the “incident angle” in the present specification indicates the incident angle of a light beam to the lens surface. This angle is expressed simply by the term “incident angle” in the present specification.

When, for example, a conventional common antireflection multilayer film is solely formed in a lens element, the reflection factor (the antireflection effect) of the light incident onto the imaging optical system depends on the wavelength of the incident light.

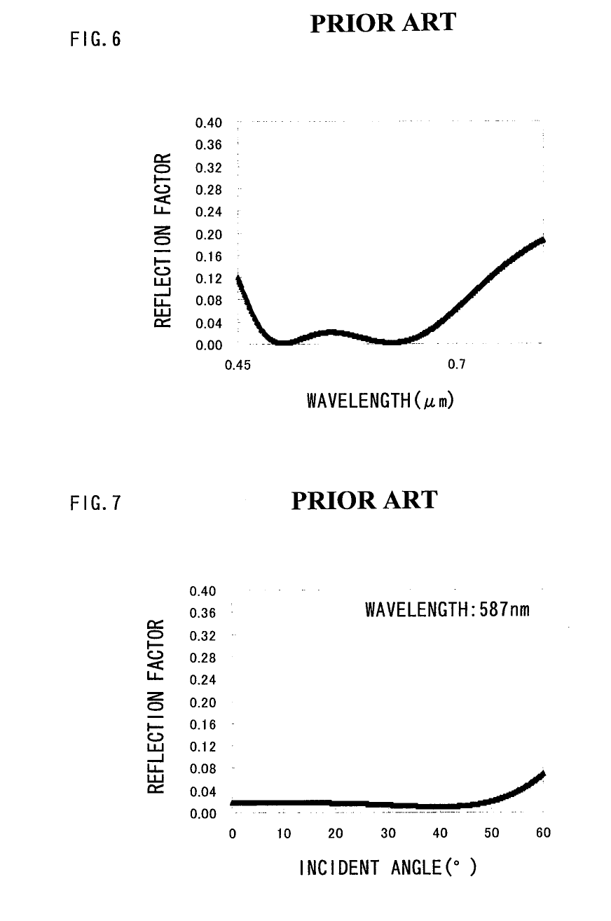

FIG. 6 is a graph showing the relation between the wavelength of incident light and the reflection factor (the wavelength dependence of antireflection effect) for the case of a lens element in which a conventional common antireflection multilayer film is formed solely. In FIG. 6, the vertical axis indicates the reflection factor, while the horizontal axis indicates the wavelength (μm) of incident light.

The antireflection multilayer film employed here has a three-layer configuration, and is composed of a film in which ¼λ of Al₂O₃, ½λ of ZrO₂ and ¼λ of MgF₂ (in order from the substrate side) are formed on a BK7 substrate. Here, λ is 587 nm.

As seen from FIG. 6, the reflection factor near 587 nm which is the center wavelength used in designing the imaging optical system 1 is suppressed. Nevertheless, there is a tendency that the reflection factor increases on the shorter wavelength side and the longer wavelength side. This shows clearly that the antireflection effect achieved by the common antireflection multilayer film depends on the wavelength.

Further, the antireflection effect varies also depending on the incident angle. Next, the influence to the antireflection effect caused by the wavelength and the incident angle of the incident light is described below.

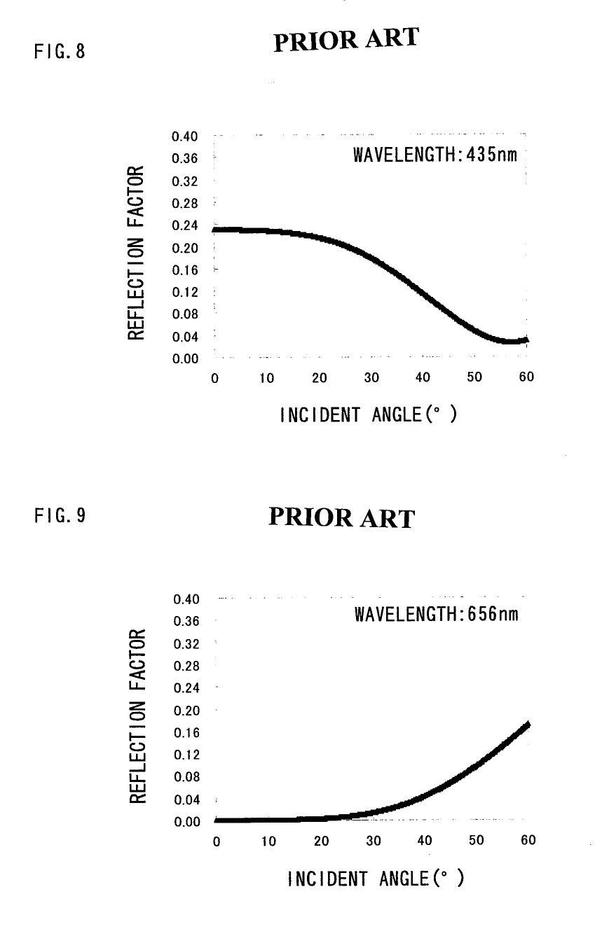

FIGS. 7, 8 and 9 are graphs showing the relation between the incident angle and the reflection factor (the incident angle dependence of antireflection effect) for the case of a lens element in which a conventional common antireflection multilayer film is formed solely. In FIGS. 7, 8 and 9, the vertical axis indicates the reflection factor, while the horizontal axis indicates the incident angle (°). Further, the graph in FIG. 7 shows a result of the case that the wavelength of the incident light is 587 nm. The graph in FIG. 8 shows a result of the case that the wavelength is 435 nm. The graph in FIG. 9 shows a result of the case that the wavelength is 656 nm.

As seen from the graph in FIG. 7, even when the incident light has the center wavelength employed in the design, the reflection factor increases with increasing incident angle. As seen from the graph in FIG. 8, when the incident light has a shorter wavelength, the reflection factor decreases with increasing incident angle. Further, as seen from the graph in FIG. 9, when the incident light has a longer wavelength, the reflection factor begins to increase near the incident angle of 20°.

As shown in FIGS. 7, 8 and 9, the antireflection effect achieved by the common antireflection multilayer film depends on the wavelength. Further, the antireflection effect degrades with increasing incident angle with a border near an incident angle of 15 to 20°.

As seen from the above-mentioned results, on an optical surface where the tilt angle is expected to become large, it is preferable that an antireflection function is imparted by means of an antireflection structure having reduced incident angle dependence. On the other hand, priority may be imparted to the characteristics on the shorter wavelength side, so that the antireflection structure may be employed up to the vicinity of the tilt angle where balance is maintained between the reflection factor on the shorter wavelength side and the reflection factor on the longer wavelength side, that is, the tilt angle where the reflection factor on the shorter wavelength side and the reflection factor on the longer wavelength side becomes approximately equal to each other. Thus, it is preferable that the region of the antireflection structure to be formed on the optical surface is determined such that the boundary between the antireflection structure and the antireflection multilayer film, that is, the boundary between the peripheral region and the center region of the optical surface, satisfies the following condition (1).

RD×0.20<BR<RD×0.70 (1)

where,

RD is a radius of curvature of the optical surface, and

BR is a distance in a radial direction measured from the optical axis to the boundary between the peripheral region and the center region.

Here, the condition (1) holds for an optical surface having a curvature.

The lower limit RD×0.20 is a value where the incident angle is approximately 15°, that is, a value where sin 15° is satisfied. When BR is smaller than RD×0.20, this situation indicates that despite that a sufficient antireflection effect has been achieved by the antireflection multilayer film, the antireflection structure has been formed beyond a necessary region. This causes difficulty in ensuring a sufficient space for holding the lens element. Thus, handling becomes difficult and mass productivity degrades. At the same time, a possibility of defects such as scratching arises.

On the other hand, the upper limit RD×0.70 is a value where the incident angle is approximately 45°, that is, a value where sin 45° is satisfied. When BR exceeds RD×0.70, the reflection factor on the longer wavelength side increases remarkably so as to cause a possibility of loss in the amount of light and degradation in the image quality.

Further, it is more preferable that the boundary between the antireflection structure and the antireflection multilayer film, that is, the boundary between the peripheral region and the center region of the optical surface, satisfies the following condition (1a).

RD×0.25<BR (1a)

where,

RD is a radius of curvature of the optical surface, and

BR is a distance in a radial direction measured from the optical axis to the boundary between the peripheral region and the center region.

RD×0.25 is a value where the incident angle is approximately 17.5°. When the condition (1a) is satisfied, a still higher antireflection effect is achieved by the antireflection structure in a state that a sufficient space for holding the lens element is ensured.

Further, it is particularly preferable that the boundary between the antireflection structure and the antireflection multilayer film, that is, the boundary between the peripheral region and the center region of the optical surface, is determined such as to satisfy the following condition (1b).

RD×0.40<BR<RD×0.60 (1b)

where,

RD is a radius of curvature of the optical surface, and

BR is a distance in a radial direction measured from the optical axis to the boundary between the peripheral region and the center region.

The lower limit RD×0.40 is a value where the incident angle is approximately 25°. Further, the upper limit RD×0.60 is a value where the incident angle is approximately 40°.

As described above, in the imaging optical system according to the present Embodiment 1, the antireflection effect achieved by an antireflection multilayer film works satisfactorily in the center region of the optical surface of the lens element. At the same time, an antireflection structure is formed in the peripheral region of the optical surface where the incident angle of the light beam increases so that the effect achieved by the antireflection multilayer film varies. Accordingly, in the imaging optical system according to Embodiment 1, damage and dirt are reduced in the vicinity of the optical axis on the optical surface (the vicinity of the surface apex part) where damage and dirt are caused comparatively easily. At the same time, the reflection factor is reduced satisfactorily in the peripheral region of the optical surface where the antireflection function achieved by the antireflection multilayer film degrades easily, so that loss in the amount of light and degradation in the image quality caused by reflection of unnecessary light are reduced remarkably.

The multilayer film for achieving the antireflection effect is not limited to a multilayer film having a three-layer configuration described above, and may be a multilayer film having a multilayer configuration of, for example, four or more layers. Further, the multilayer film may be a film in which a film such as a protection film having another function other than the antireflection function is laminated to a multilayer film having a layered configuration. Furthermore, a single layer film having an antireflection function may be employed. Also in these cases, an effect similar to that obtained when the multilayer film having a three-layer configuration is employed is achieved.

Further, the boundary between the antireflection multilayer film and the antireflection structure need not strictly be distinctive. That is, the antireflection multilayer film and the antireflection structure may partly overlap with each other. When the boundary between the antireflection multilayer film and the antireflection structure has a finite region where the two overlap with each other as described here, a sufficient antireflection effect is obtained under consideration of actual productivity.

### Embodiment 2

In Embodiment 1, an antireflection multilayer film is formed in the center region of the lens element located on the most object side, while an antireflection structure is formed in the peripheral region. Here, the antireflection multilayer film may be formed such as to cover the entire surface of the lens element, and then the antireflection structure may be formed thereon.

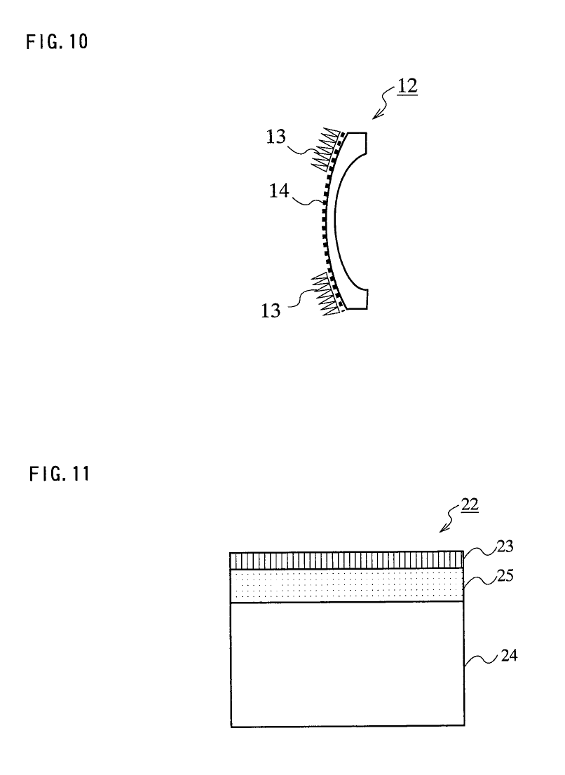

The basic configuration of an imaging optical system according to the present Embodiment 2 is similar to that of the imaging optical system according to Embodiment 1. Thus, FIG. 1 is to be referred to concerning the configuration of the imaging optical system. Here, the lens element 2 in FIG. 1 is replaced by a lens element 12 shown in the following FIG. 10 in the present Embodiment 2.

FIG. 10 is an enlarged view of a lens element 12 employed in an imaging optical system according to Embodiment 2. In FIG. 10, an antireflection multilayer film 14 is formed such as to cover the entire surface of the lens element 12. Similarly to the lens element 2 in Embodiment 1, the lens element 12 has an antireflection structure 13 in at least part of the peripheral region of the optical surface. This situation of the lens element 12 is different from that of the lens element 2 according to Embodiment 1 in the point that the antireflection multilayer film 14 is formed on the substantially entire surface of the optical surface of the lens element 12.

The antireflection structure 13 shown in FIG. 10 corresponds to the antireflection structure 3 shown in FIG. 1. Further, the method for determining the boundary between the peripheral region and the center region is similar to the method in Embodiment 1.

As described above, in the present Embodiment 2, an antireflection multilayer film is formed on the substantially entire surface of the optical surface of the lens element, while an antireflection structure is formed in at least part of the peripheral region of the optical surface. This avoids the necessity of high positioning precision at the time of forming the antireflection multilayer film on the optical surface, which is required when the antireflection multilayer film is formed only in the center region of the optical surface. Further, in an actual process of multilayer film formation, special tools such as a mask become unnecessary which are required when the multilayer film is formed only in the center region of the optical surface. Furthermore, also in the formation of the antireflection structure, the shape may be adjusted with a loose tolerance relative to the boundary.

### Embodiment 3

The basic configuration of an imaging optical system according to the present Embodiment 3 is similar to that of the imaging optical system according to Embodiment 1. However, in the lens element located on the most object side, the configuration of an antireflection structure provided in at least part of the peripheral region of the object side optical surface is different from the configuration of the antireflection structure in Embodiment 1.

FIG. 11 is an enlarged sectional part view of a lens element 22 employed in an imaging optical system according to Embodiment 3. The lens element 22 corresponds to the lens element 2 shown in FIG. 1, and is the lens element located on the most object side in the imaging optical system 1 of FIG. 1. As shown in FIG. 11, a sheet 25 having an antireflection structure 23 is stuck in at least part of the peripheral region of a substrate 24 that constitutes the lens element 22 and is composed of, for example, a material capable of absorbing the incident light.

For example, the sheet 25 is composed of a transparent resin material such as acrylic resin. On at least part of its surface, an antireflection structure 23 is provided in which structural units having a predetermined shape are arranged periodically in the form of an array at a period smaller than the minimum wavelength of light whose reflection should be prevented in the incident light. The thickness of the sheet 25 may be any value as long as handling is easy and sufficient mechanical strength is obtained. A preferable thickness is 10 μm or greater.

The height of the structural units constituting the antireflection structure 23 and the period of arrangement of the structural units may be determined similarly to Embodiment 1. For example, when the incident light is visible light, it is preferable that an antireflection structure 23 is formed such that, for example, structural units of conical shape having a height of 0.15 μm are arranged on the sheet 25 periodically in the form of an array at a period of 0.15 μm as shown in FIG. 3A. The antireflection structure 23 corresponds to a structure in which structural units having a height greater than or equal to the period are arranged periodically in the form of an array at a period smaller than the wavelength range of visible light.

It is preferable that the difference between the refractive index of the sheet 25 and the refractive index of the substrate 24 is 0.2 or smaller. When the difference of these refractive indices is set up to be 0.2 or smaller, the reflection factor generated at the interface between the sheet 25 and the substrate 24 can sufficiently be suppressed to a negligible level. Further, it is particularly preferable that the difference between the refractive index of the sheet 25 and the refractive index of the substrate 24 is 0.1 or smaller. When the difference of these refractive indices is set up to be 0.1 or smaller, the reflection factor generated at the interface between the sheet 25 and the substrate 24 can be reduced further so that the generation of stray light can be suppressed efficiently.

The manufacturing method for the sheet 25 having the antireflection structure 23 is not limited to a particular one. An exemplary method is as follows. First, a pattern is generated on a quartz glass substrate or the like by a technique such as electron beam lithography. Then, a shape identical to the antireflection structure 23 is formed by dry etching or the like. As a result of this precision processing, a precision master mold is obtained. Then, using the master mold, press molding is performed on a glass material having been softened by heating so that a glass antireflection structure molding die is obtained. Finally, using the antireflection structure molding die, press molding is performed on a resin material such as an acrylic resin material, so that a sheet 25 having the antireflection structure 23 is obtained. When such a method is adopted, the sheet 25 in which the antireflection structure 23 is provided in at least part of its surface can be manufactured at low cost and in large quantities.

From the point that handling is easy and sufficient mechanical strength is obtained, it is preferable that the acrylic resin material used in the press molding is a material having a thickness of approximately 10 μm or greater (thickness of the sheet 25+0.15 μm).

As described above, in the present Embodiment 3, the sheet 25 having the antireflection structure 23 is stuck onto the surface of the substrate 24 composed of, for example, a material capable of absorbing the incident light, so that unnecessary light in the incident light is satisfactorily prevented from being reflected at the interface with the air. Thus, an antireflection function can be imparted to a desired optical surface easily at low cost.

Embodiment 3 has been described for an exemplary case that the material of the sheet is an acrylic resin. However, in place of the acrylic resin, polycarbonate, polyethylene terephthalate or the like may be employed.

Further, Embodiment 3 has been described for an exemplary case that the structural units of the antireflection structure are structural units of, for example, conical shape (FIG. 3A). However, similarly to Embodiment 1, the structural units of the antireflection structure are not limited to such structural units of conical shape, and may be, for example, structural units of pyramid shape (FIG. 3B) such as regular hexagonal pyramid shape and square pyramid shape. Further, these structural units are not limited to structural units of tapered shape, and may be structural units of bell shape (FIGS. 4A and 4B) having a rounded tip or alternatively structural units of truncated tapered shape such as truncated conical shape (FIG. 5A) and truncated pyramid shape (FIG. 5B). Furthermore, each structural unit need not have an exact geometric shape. That is, it is sufficient that each structural unit has substantially a tapered shape, a bell shape, a truncated tapered shape or the like. Further, similarly to Embodiment 1, the structural units of the antireflection structure may have a protruding shape, and may have a recess shape.

Embodiments 1 to 3 have been described for an exemplary case that the lens element having an antireflection structure is the lens element located on the most object side of the imaging optical system. However, another lens element contained in the imaging optical system may have the antireflection structure. Here, when mass productivity is to be taken into consideration, it is difficult that the edge of the lens element is solely held at the time when the lens element is inserted into the lens barrel. Thus, in general, the lens element is held by a method of suctioning the lens surface. Accordingly, when an antireflection structure is formed in the center region of the optical surface of the lens element, the structural units of the antireflection structure could be damaged or removed at the time of suctioning in some cases. Thus, even when an antireflection structure is formed on the optical surface of another lens element contained in the imaging optical system, the antireflection structure is formed in the peripheral region located in the periphery of the center region of the optical surface regardless of the concave or convex shape and the radius of curvature of the optical surface.

Next, the imaging optical system according to the present invention is described below in further detail with reference to the following example. However, the present invention is not limited to this particular example.

### Example

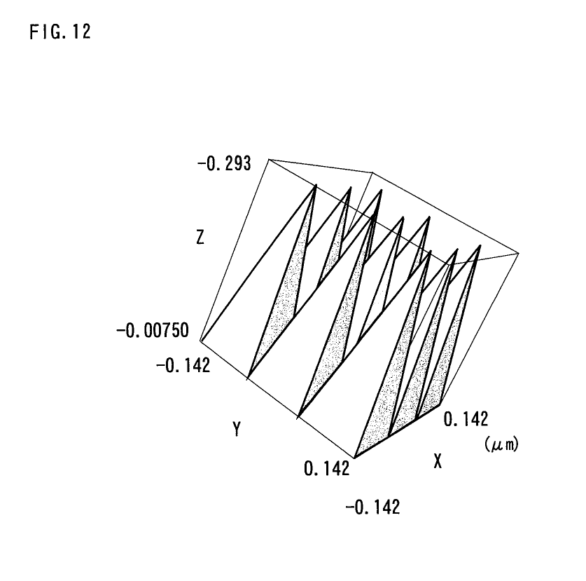

The imaging optical system according to the present example corresponds to the imaging optical system according to Embodiment 1 shown in FIG. 1. FIG. 12 is a schematic enlarged view showing an antireflection structure formed on the object side optical surface of the lens element located on the most object side among the lens elements contained in the imaging optical system in the present example. The antireflection structure shown in FIG. 12 is s structure in which structural units of a square pyramid shape having a height of approximately 300 nm are arranged periodically in the form of an array at a period of approximately 100 nm. Further, the substrate constituting the antireflection structure is composed of BK7.

The relation between the incident angle and the reflection factor for the case that light is incident on the lens element in which the antireflection structure shown in FIG. 12 is formed was calculated by a simulation. The technique used in the simulation is an RCWA (Rigorous Coupled Wave Analysis). Here, the RCWA is one of exact calculation methods for calculating the behavior of electromagnetic waves in a diffraction grating. This method is described in detail in References 1 and 2 listed below.
Reference 1: M. G. Moharam and T. K. Gaylord; “Rigorous coupled-wave analysis of planar-grating diffraction”, J. Opt. Soc. Am. 71 (1981)811-818
Reference 2: M. G. Moharam; “Coupled-Wave Analysis of Two Dimensional Dielectric Gratings”, SPIE—The International Society for Optical Engineering 883 (1988)8-11

The simulation has been performed for a case that the incident object is an object formed in plane. In the simulation with variation of the angle, incident was performed at individual angles relative to the object formed in plane. Here, the calculations of the simulation were performed with the assumption that the antireflection structure was present continuously and that the area of the antireflection structure and the number of structural units were infinite.

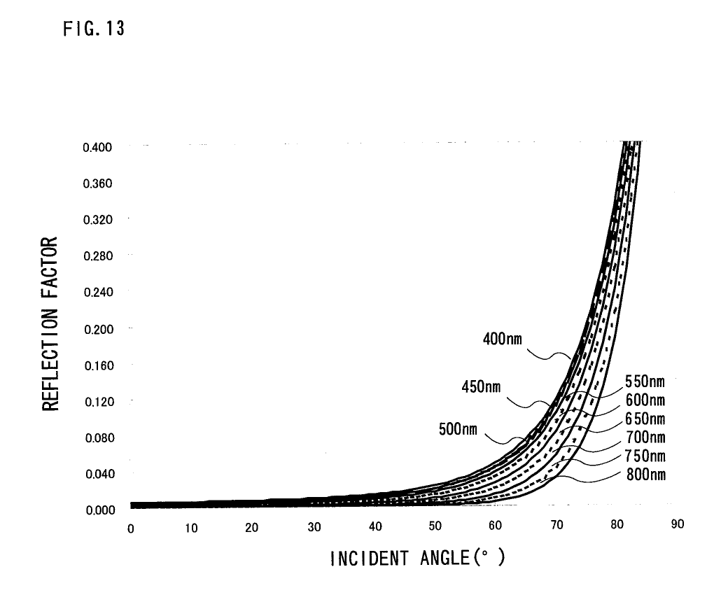

The result obtained by the simulation is shown in the graph in FIG. 13. FIG. 13 is a graph showing the relation (incident angle dependence of reflection factor characteristics) between the incident angle of each incident light and the reflection factor in a case that the wavelength of the incident light was changed in a wavelength range between 400 and 800 nm by a step of 50 nm. In FIG. 13, the vertical axis indicates the reflection factor, while the horizontal axis indicates the incident angle (°).

As shown in FIG. 13, in the lens element in which the antireflection structure shown in FIG. 12 is formed according to the present example, the graph showing the relation between the incident angle and the reflection factor has almost the same shape even for different wavelengths of the incident light. That is, the difference of incident angle dependence is small for each wavelength. In contrast, as shown in FIGS. 7 to 9, in the conventional lens element in which an antireflection multilayer film is formed solely, the graph showing the relation between the incident angle and the reflection factor has a largely different shape for each wavelength of the incident light. That is, the difference of the incident angle dependence is large for each wavelength.

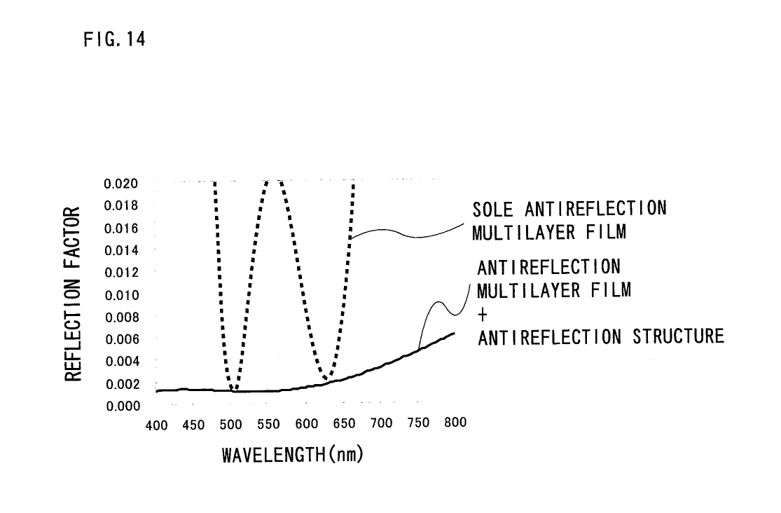

Next, the relation between the wavelength of light incident on the lens element in which the antireflection structure shown in FIG. 12 is formed and the reflection factor was calculated by a simulation. The result obtained from the simulation is shown in the graph in FIG. 14 together with the result for the conventional lens element in which the antireflection multilayer film is formed solely.

FIG. 14 is a graph showing the relation (wavelength dependence of antireflection effect) between the wavelength of incident light and the reflection factor for the cases of the lens element according to the present example and the conventional lens element. In FIG. 14, the vertical axis indicates the reflection factor, while the horizontal axis indicates the wavelength (nm) of incident light. In FIG. 14, the solid line indicates a graph for the lens element according to the present example, while the dashed line indicates a graph for the conventional lens element. Here, the graph for the conventional lens element is generated by fitting the scale of the graph in FIG. 6 into that of FIG. 14.

As shown in FIG. 14, in the lens element according to the present example, the reflection factor can be suppressed low in a wide wavelength range. As seen from FIG. 14, the reflection factor is suppressed into approximately 0.006 even near the wavelength of 800 nm where the reflection factor is the highest. In contrast, in the conventional lens element in which an antireflection multilayer film is formed solely, even near the wavelength of 500 nm and near the wavelength of 650 nm where the reflection factor is the lowest, the reflection factor exceeds that of the lens element according to the present example near the same wavelength.

As described above, according to the present example, an imaging optical system is provided in which the reflection factor is satisfactorily suppressed on an optical surface and in which handling is easy and satisfactory mass productivity is obtained.

### INDUSTRIAL APPLICABILITY

In an imaging optical system according to the present invention, the reflection factor is suppressed on an optical surface while handling is easy and satisfactory mass productivity is obtained. Thus, the imaging optical system is suitably applicable to various imaging devices such as digital cameras.

1. An imaging optical system provided with at least one lens element, comprising:
an optical surface through which incident light transmits; and
an antireflection structure provided in at least part of a peripheral region located in the periphery of a center region containing the center of an optical surface in one or more optical surfaces, wherein
the peripheral region is within an optical effective diameter, and wherein
the antireflection structure is a structure in which structural units having a predetermined shape are arranged periodically in the form of an array at a period smaller than a minimum wavelength of light whose reflection should be prevented in the incident light.

2. The imaging optical system as claimed in claim 1, wherein a multilayer film is formed in at least part of the center region of the optical surface.

3. The imaging optical system as claimed in claim 2, wherein the multilayer film is an antireflection multilayer film having an antireflection function.

4. The imaging optical system as claimed in claim 2, wherein the multilayer film and the antireflection structure overlap partly with each other.

5. The imaging optical system as claimed in claim 1, wherein the antireflection structure is formed from a resin material.

6. The imaging optical system as claimed in claim 1, wherein the boundary between the peripheral region and the center region satisfies the following condition (1):
RD×0.20<BR<RD×0.70 (1)
where,
RD is a radius of curvature of the optical surface, and
BR is a distance in a radial direction measured from the optical axis to the boundary between the peripheral region and the center region.

7. The imaging optical system as claimed in claim 1, wherein the optical surface having the antireflection structure is the object side optical surface of the lens element located on the most object side.
